(19) United States
(12) Patent Application Publication
(10) Pub. No.: US 2009/0028164 A1
(43) Pub. Date: Jan. 29, 2009

(54) METHOD AND APPARATUS FOR SEMANTIC SERIALIZING

(75) Inventor: Martin Christian Hirsch, Berlin (DE)

Correspondence Address: INTELLECTUAL PROPERTY / TECHNOLOGY LAW, PO BOX 14329, RESEARCH TRIANGLE PARK, NC, 27709, US

(73) Assignee: SEMGINE, GMBH, Berlin (DE)

(21) Appl. No.: 11/781,394

(22) Filed: Jul. 23, 2007

(51) Int. Cl. H04L 12/28; H04L 12/56

(52) U.S. Cl. 370/400; 370/254

(57) ABSTRACT

A method and an apparatus for serializing a plurality of information elements that are extracted from a plurality of information sources and represented by nodes in a semantic network. The nodes are connected to other nodes via a plurality of connecting edges, and each of the connecting edges has at least one edge property value. The method includes selecting an initial node of the plurality of nodes and determining one of the at least one node property values of first order connecting nodes connected to the initial node, determining a first node connected to the initial node by the connecting edge having a highest value of the at least one node property value, examining further first order connecting nodes connected to the first node and determining a relevance order of the further first order connecting nodes connected to the first node and serializing the plurality of information elements in accordance with the relevance order of the further first order connecting nodes to produce a serial list.

### CROSS-REFERENCE TO RELATED APPLICATIONS

The present application is related to the following co-pending patent applications, which are assigned to the assignee of the present application and incorporated herein by reference in their entireties:

U.S. patent application Ser. No. 11/778,529 filed on 16 Jul. 2007 entitled “Semantic Parser”

U.S. patent application Ser. No. 11/778,513 filed on 16 Jul. 2007 entitled “Semantic Crawler”

### BACKGROUND OF THE INVENTION

The present invention relates to a computer aided method and an apparatus for serializing a plurality of related information elements, for example, subject nouns, verbs, object nouns to obtain a serial list indicating the relationship between the related information elements. The plurality of information elements is extracted from at least one information source. The at least one information source can be, for example, an electronic text document comprising information, i.e. textual elements.

### BRIEF DESCRIPTION OF THE RELATED ART

In recent years, the analysis of a vast amount of available information sources, such as electronic text documents, Internet web pages, digital scientific publications, mailing lists, electronic text databases, etc. has become more and more important, for example, in business, science applications, etc.

As a result of the tremendous increased number of information or information sources that are, for example, available via electronic communication networks such as the Internet, intranet, etc. there is a need for efficient handling and evaluating of the vast amount of information and, in particular, to understand the meaning of the information. The processing is, in particular, assisted by computer hardware, because otherwise it is difficult, almost even impossible, for a user wanting specific information about an issue to evaluate relevant ones of the information sources in an effective way and further process all available relevant information sources for this issue.

In the field of computational linguistics attempts have been made to analyze and process languages by computer algorithms. The Applicant's co-pending U.S. patent application Ser. No. 11/778,529 filed 16 Jul. 2007 for “Semantic Parser” discloses a method of parsing an information source in order to generate a graph with a plurality of nodes representing information elements. The information elements can have a weight attached to them and the edges between the information elements can also have a weight attached to them.

The Applicant's co-pending U.S. patent application Ser. No. 11/350,095 filed Feb. 9, 2006 for “Apparatus and Methods for an Item Retrieval System” discloses a method in which the weighting of the nodes and edges of the graph can be adjusted to take into account the context in which a search is carried out.

While the prior art methods above allow the generation of graphs to represent the information content and the relationship between the information elements, the prior art methods do not disclose any method by which a researcher can identify a chain or serial link of important elements. Suppose for example, a medical researcher is interested in understanding the properties of the von Willebrand factor protein and its effects on disease, then the analysis of the graph will allow a connection to be made between the different information elements related to the von Willebrand factor which are identified by parsing documents relating to the von Willebrand factor (as well as other medical literature). This will be extremely time-consuming for the medical researcher and is unlikely to be efficient. The medical researcher is looking instead for a chain or serial link between the most relevant information elements in the graph. In other words, the medical researcher wishes to start from the most important or most relevant information element for the subject in which he or she is interested and then to traverse the edges of the graph to identify the important related information elements and the degree of importance of the related information elements. The term “degree of importance” can have different values in different contexts and such fact needs to be taken into account. The pharmacologist, for example, will have a different focus of his or her search than the clinician. The pharmacologist may well be interested in putative effects of medicaments from a biochemical point of view. The clinician on the other hand is less interested in biochemistry but more interested in symptoms and as well as treatments.

Prior art methods have focused on the ranking of the information sources (such as an electronic text document containing human language text) itself in order to determine the most relevant ones of the information sources and not to loose an overview of the information sources. Otherwise, it would be impossible to determine or find the most useful one of the plurality of information sources. Ranking is often used for indexing or categorizing web content of, for example, web sites, i.e. information, which is distributed over the Internet. However, ranking does not allow a serial link of the individual information elements from the information sources. Ranking only allows the identification of the most important information sources and the researcher must review the document to obtain the required information. For example, ranking algorithms in Google use the number of links to the document as an indication of the importance of the document.

### SUMMARY OF THE INVENTION

According to the present invention, there is provided a method for serializing a plurality of information elements. In this application “serializing” means generating a serial link or chain between ones of the plurality of information elements. Each one of the plurality of information elements is extracted from at least one information source. Each one of the plurality of information elements is represented by one of a plurality of nodes in at least one semantic network and each node may have at least one node property value. The semantic network is a representation of information contained in the information source or information sources. The semantic network can be graphically represented by nodes and edges. Ones of the plurality of nodes are connected to other ones of the plurality of nodes in the semantic network via a plurality of connecting edges. At least one edge property value is associated with each one of the plurality of connecting edges. At least one node property value is associated with each one of the plurality of nodes.

The method according to the invention comprises selecting an initial node of the plurality of nodes and determining at least one of the at least one node property values of first order connecting nodes. The first order connecting nodes are connected directly to the initial node via connecting edges. The initial node corresponds, for example, to the information element about which a researcher is seeking information. In a next phase, a first node (which is directly connected to the initial node by one of the connecting edges) is determined. This is done by choosing the first node having a highest value of the at least one node property value. In one aspect of the invention, the first node property value of the first node comprises a highest number of connecting edges. Having determined the first node, further first order connecting nodes connected to the first node are examined and a relevance order of the further first order connecting nodes connected to the first node is determined. This relevance order depends on the at least one edge property values and/or the at least one node property values. The relevance order is, for example, the number of connecting edges of the further first order connecting nodes and/or weights of the connecting edges.

In an alternative aspect of the invention, the relevance order also depends on the at least one node property values. As already mentioned, the first node can be selected as the one node having the largest number of connecting edges to the further first order connecting nodes. Finally the plurality of information elements is serialized in accordance with the relevance order of the further first order connecting nodes to produce a serial list.

The method according to the present invention allows, for example, the generation of the serial list which is the basis for “telling” a story about the information element associated with the reference (initial) node in an order which is understandable to the researcher. The serial list contains only those information elements which are most closely related to the reference (initial) node. The information elements could be, but are not limited to, subject nouns, verbs, object nouns, picture elements, photos, etc. The relevance order can be, for example, determined by examining a product of the at least one node property value and the at least one edge property value of the connecting edge between the first node and the further first order connecting node.

The basis for such the method for semantic linking (serializing) is a representation of the plurality of information sources as a semantic network (graph). The semantic network can be, for example, generated from at least a portion of at least one information source as described in detail in the Applicant's co-pending U.S. patent application Ser. No. 11/778,529 filed on 16 Jul. 2007 for “Semantic Parser.”

In accordance with a second aspect of the invention, the initial node is revisited and a second node is determined with the at least one node property value having a second highest value. In one aspect of the invention, the second node that is directly connected to the initial node comprises the second largest number of connecting edges. The further first order connecting nodes connected to this second node are then examined in a similar manner as that described above and the information elements associated with the nodes are added to the serial list in accordance with their relevance order.

In accordance to a further aspect of the invention, the first order connecting nodes which are connected to the first node can be determined by identifying the number of common nodes which are both in connection with the first node and the further first order connecting nodes via at least one connecting edge. This allows, for example, examining and determining always the next or further most relevant node.

In accordance to a further aspect of the invention, the first node and the examined further first order connecting nodes can represent a local graph. The local graph can be a k-graph. Such a graph can be, for example, generated from at least one information source as described in detail in the co-pending U.S. patent application Ser. No. 11/778,529 entitled “Semantic Parser”.

The at least one edge property value and/or the at least one node property value can be selected from the group consisting of a frequency number, activation information, etc. This allows the relevance order to be adjusted in context with the searcher's needs.

In accordance to a further aspect of the invention, each one of the plurality of serialized information elements may represent a different one of the plurality of serialized information elements than a further one of the plurality of serialized information elements.

In accordance to another aspect of the invention, an apparatus is provided for serializing a plurality of information elements which implements the method as discussed above. The apparatus has at least one graph examination and determination engine as well as at least one serializing engine for serializing (producing) the serial list.

In accordance with another aspect of the invention, there is provided a computer readable tangible medium which stores instructions for implementing the method according to the invention run on a computer. The instructions control the computer, i.e. the electronic data processing apparatus, to perform the process of serializing a plurality of information elements as discussed previously. The computer readable tangible medium can be, for example, a floppy disk, CD-ROM, DVD, USB flash memory or any other kind of storage device. Alternatively, the instructions for implementing and executing the method according to the present invention can be downloaded via communications networks such as intranets, the Internet, etc. In an alternative aspect of the invention, the instructions for implementing and executing the method according to the present invention can be stored on a mobile communication device with access to a communications network such as a mobile phone, etc. 4

In accordance with a further aspect of the invention, a computer program product is provided. The computer program product is loadable into at least one memory of a computer readable tangible medium or into an electronic data processing apparatus. Such an apparatus can be, for example, an apparatus as described above. The computer program product comprises program code means to perform the serializing of a plurality of information elements as discussed previously.

According to another aspect of the invention, the method according to the present invention can be implemented in web browsers or linked to web browsers to assist the web browsers which have access to communication networks such as intranets, the Internet, etc.

According to a further aspect of the invention, the method according to the invention can be implemented in search algorithms of, for example, well-known search services of search-engines to improve their efficiency, quality and reliability. According to a further aspect of the invention, a search engine apparatus for executing or performing the method as discussed previously is provided.

These together with other possible and exemplary aspects and objects that will be subsequently apparent, reside in the details of construction and operation as more fully herein described and claimed, with reference being had to the accompanying figures.

Further, it is clear to those of ordinary skill in the art that the disclosed characteristics and features of the invention can be arbitrarily combined with each other.

### BRIEF DESCRIPTION OF THE DRAWINGS

FIG. 1 is a graphical representation of a section of a graph;

FIG. 2 is a flowchart of an example of the method according to the invention;

FIG. 3 is a schematic representation of an example of an apparatus for performing the method according to the invention.

### DETAILED DESCRIPTION OF THE INVENTION

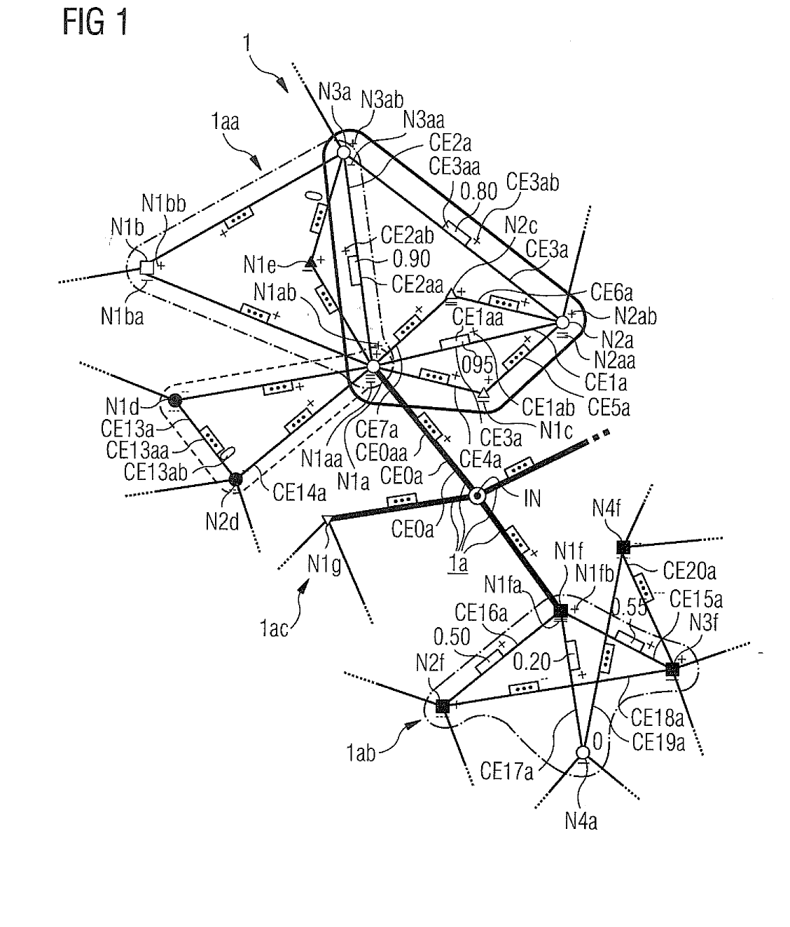

FIG. 1 shows a graphical representation of a section of a semantic network. The semantic network is represented as a graph. The section of the semantic network is the graph 1. The semantic network can be generated from a plurality of information sources and is described in detail in the co-pending U.S. patent application Ser. No. 11/778,529 filed on 16 Jul. 2007 for “Semantic Parser.” The graph 1 is merely a subset of the semantic network as will become clearer later.

Each information source can be, for example, an electronic text document, i.e. a text document that can be processed by an electronic data processing apparatus. The text documents may be of any kind, such as law text, scientific publications, novella, stories, newspaper articles, textbooks, catalogues, description texts, etc. The text documents may comprise human language text.

It should be noted that the kind of the information source, i.e. text document is not only limited to human language text, but can also contain computer programming language text, for example, HTTP, C, JAVA, Perl source code, etc, i.e. any other language or kind of language with a syntax, syntax elements, operators, etc.

In an alternative aspect of the invention, an information source can be, for example, an electronic picture. The electronic picture can be, for example, of JPG format, TIF format, BMP format or any other format that is able to be processed, for example, by an electronic data processing apparatus such as computer, etc.

According to a further aspect of the invention, an information source can be, for example, an electronic music data file or video data file or any other kind of multimedia data files. The electronic music data file can be, for example, of MP3 format, WAV format, WMA format, etc.

If the information sources are, as already mentioned, text documents of human language, each one of information portions within the information sources, i.e. the text documents, may represent a sentence or a plurality of sentences, i.e. a paragraph. Then, the information elements can be subject nouns (i.e. substantives), verbs, object nouns, adjectives, etc.

The graph 1 in FIG. 1 represents a plurality of such information elements. In FIG. 1 the four nodes N1a, N2a, N3a, N4a (represented as circle symbols) represent information elements that are extracted from a first text document. Further nodes of the graph 1 that are shown in FIG. 1 are: the node N1b (extracted information element from a second text document and represented as a square), the two nodes N1c, N2c (extracted information elements from a third text document and represented as triangles), the two nodes N1d, N2d (extracted information elements from a fourth text document and represented as filled dots), the node N1e (extracted information element from a fifth document and represented as a filled triangle), the four nodes N1f, N2f, N3f, N4f (extracted information elements from a sixth document and represented as filled squares) and the node N1g (extracted information element from a seventh document and represented as an upside down triangle). It is, of course, possible that the same information elements are present in more than one of the text documents.

Each node N1a to N1g of the graph 1 as well as further nodes that are not explicitly shown in FIG. 1 represents one of the information elements which is either a subject noun or an object noun. The nodes N1a to N1g are associated among each other via connecting edges CE0a to CE20a, i.e. each of the nodes N1a to N1g are connected to further different ones of the nodes N1a to N1g. Each one of the connecting edges CE0a to CE20a may represent, for example, verbs as further information elements extracted from a plurality of text documents. The verbs connect the subject nouns with the corresponding object nouns in the information sources resulting in a specific meaning of the information elements. This specific meaning corresponds to sentences within the information source.

Each one of the nodes N1a to N1g can have at least one node property. The at least one node property has at least one node property value. With regard to the example of the graph 1 in FIG. 1, each one of the nodes N1a to N1g comprises or is associated with corresponding node properties with corresponding node property values.

For example, the first node N1a comprises or is associated with a frequency number N1aa. The frequency number N1aa is the first node property value or the first node weight of the first node N1a and represents the number of the corresponding information element contained in the plurality of text documents. One example would be the number of times that the term corresponding to the information element appeared in the text document. As already mentioned, a further node property value of a node is the number of connecting edges of the node.

It should be noted that the value of the first node property value does not need to be static. For example, the value of the first node property value can be dynamic. The value of the first node property value could change depending on the context in which a search takes place as will be discussed below.

In the graphical representation of the graph 1 in FIG. 1, the frequency numbers N1aa, N2aa, N3aa, N1ba, etc. are exemplary graphically represented for the corresponding nodes N1a to N1b by a number of underlines beneath each ones of the node symbol (circles, squares, triangles, dots).

The first node N1a has or is further associated with an activation information N1ab (marked with at least one “+” sign, i.e. here with two “+” signs). The activation information N1ab of the first node N1a is the second node property value, i.e. the second node weight, and represents the status of the corresponding information element in the plurality of text documents. The Applicant's co-pending patent application “Apparatus and Methods for an Item Retrieval System” discusses the use of activation information, also called “activation energies” which can be used to change the value of the first node property values and the principles can be used in this invention. It is clear for the person skilled in the art that the same aspects relate to the remaining nodes N2a to N1g of the graph 1 and the further nodes which are not explicitly shown in FIG. 1.

Each one of the connecting edges CE0a to CE20a. can also have at least one edge property value, i.e. an edge weight. For example, the first connecting edge CE1a, connecting the first node N1a with the second node N2a, has two edge property values. The first edge property value CE1aa represents the strength coupling between the first node N1a and the second node N2a. The strength coupling or the strength coupling value can represent the frequency number of a coupling information element between two different further information elements. The two different further information elements being represented as nodes in the graph 1. For example, the strength coupling can be derived from the frequency number of connections between two identical relevant information elements. For example, in the text document the frequency number could represent the number of times the same subject noun is connected with the same object noun.

The first connecting edge CE1a has further the second edge property value CE1ab representing activation information (also marked with a “+” sign as in the case of the nodes). In a similar manner to that explained above with respect to the nodes, the connecting edges can be in an activated status or deactivated (passive) status. The person skilled in the art will recognize that the same aspects relate to the remaining connecting edges CE2a to CE20a of the graph 1 and to the further connecting edges which are not explicitly shown in FIG. 1.

The activation of the nodes and/or the edges is discussed above and can depend, for example, on the frequency of the nodes and/or edges and the context of the search. It should be noted that the nodes and edges are shown only as activated or deactivated in this example. However, the activation energies can be different for each one of the nodes and/or the connecting edges. If a connecting edge (see CE13a in FIG. 1) is in a deactivated status (see the second edge property value CE13ab which is represented in the graph 1 of FIG. 1 with a “0” sign), then the connecting edge CE13a between the node N1d and N2d, i.e. the relation of the node N1d and N2d via this connecting edge CE13a does not contribute to the serializing phase according to the method of the present invention. The same principle can apply to the nodes.

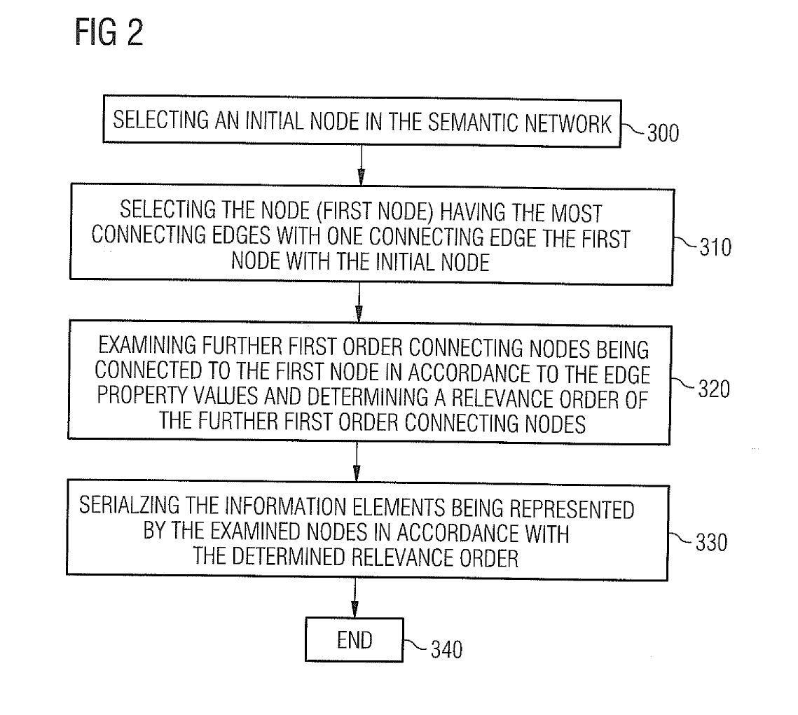

FIG. 2 represents a flowchart of the main phases of an example of the method according to the present invention. The method can be started with step 300 by defining (or selecting) and determining an initial node IN within the graph 1. The initial node IN is a reference node and represents the start information item of the search. The initial node IN is a term about which, for example, a researcher wants to find a “story”, i.e. the researcher wants to know information about the information elements relating to the initial node IN. In other words, the researcher wishes to have the information prepared in a context-sensitive manner with regard to the information element representing the initial node IN.

An example, as described below, will serve to illustrate this. Suppose the researcher is a medical researcher who wishes to get information and obtain information about the protein “Von Willebrand factor”. The semantic network used for performing the method of serializing according to the present invention represents a plurality of medical text documents about proteins, in particular glycoproteins. These medical text documents contain the information element “Von Willebrand factor” as well as other information elements. This information element (“Von Willebrand Factor”) is represented by one of the nodes in the graph 1. The node representing the information element “Von Willebrand factor” is selected as the initial node IN.

In step 310 (see FIG. 2) the local graph la for the initial node IN, representing all of the information elements having a direct (first order) connection to the initial node IN, (nodes N1a, N1f, N1g) is selected from the graph 1. The local graph 1a is therefore a first order graph 1a. The node N1a of the local graph 1a, having the most connecting edges (CE1a, CE2a, . . . ) is selected in step 310. In the example shown in FIG. 1, the node of the local graph 1a having the most connecting edges (CE1a, CE2a, . . . ) is the node N1a and this is termed a first node N1a. The information element associated with the first node N1a is the most significant information element in the story relating to the initial node IN.

In the example of FIG. 1, node N1a is determined as the first node N1a and comprises nine connecting edges. The first node N1a therefore represents the most relevant node. The first node N1a corresponds to the information element with the most relevant information or meaning with regard to the initial node IN. In the example discussed above, the initial node represents the term “Von Willebrand factor” and the first node N1a represents the term “glycoprotein”. The term “glycoprotein” is the most significant term associated with the term “von Willebrand factor” and indeed this is correct.

In step 320 a first order graph 1aa associated with the first node N1a is examined. The first order graph 1aa associated with the first node N1a is outlined in FIG. 1. In this step 320 all of the nodes N2a, N3a, N1b, N1c, etc. (being further first order connecting nodes) in the first order graph 1aa are examined as well as the connecting edges CE1a, CE2a, etc. between the first node N1a and the nodes N2a, N3a, etc. in order to determine a relevance order (i.e. an order of the most significant ones) of the nodes N2a, N3a, etc. The determination of the most significant ones of the nodes N2a, N3a, etc. is done by a determination of the product of the node property values N1aa, N2aa, etc. and the edge property values. In a simple example shown in FIG. 1 only the edge property values CE1aa, CE2aa, CE1ab, CE2ab, etc. are used of the (directly) connecting edges between one of the nodes N2a, N3a, etc. and the start node.

The second node N2a, for example, represents a second information element that is associated with the first information element represented by the first node N1a. The second node N2a is, in this example, selected as the next most relevant node depending on at least one edge property value CE1aa of the connecting edge CE 1a between the first node N1a and the second node N2a. With regard to the example of the first order graph 1aa in FIG. 1, the node N2a is determined as the most significant ones of the nodes N2a, N3a because the connecting edge CE1a comprises a first edge property value CE1aa, i.e. a strength coupling, of 0.95. This value represents the highest, i.e. maximum, value of the first edge property values CE1aa, . . . of all of the relevant (first-order) connecting edges CE0a to CE14a in the first order graph 1aa that are connected with the first node N1a. The higher values of the first edge property value CE1aa indicates the stronger relationships between the two information elements connected between the edges, i.e. the relationship between the first node N1a and the second node N2a.

With regard to the example according to which the initial node IN represents the term “Von Willebrand factor” and the first node N1a represents the term “glycoprotein”, the second node N2a represents the term “blood platelet”. The strength coupling value of 0.95 indicates that there is a strong relationship between “glycoprotein” and “blood platelet”.

In an alternative aspect of the invention, the second node N2a can be selected and determined depending on the number of common nodes which are both in direct, i.e. first-order, connection with the first node N1a and the second node N2a. In the example of FIG. 1 the first node N1a is connected to a further node N1c via a connecting edge CE4a and the second node N2a is connected to the further node N1c via a connecting edge CE5a. Further, the first node N1a is connected to yet a further node N2c via a connecting edge CE7a and the second node N2a is connected to the further node N2c via a connecting edge CE6a. Consequently the first node N1a and the second node N2a have the two common nodes N1c and N2c. Such a structural layout and configuration between the first node N1a and the second node N2a represents or implies, as already mentioned above, a strong connection between the corresponding information elements being represented by the first node N1a and the second node N2a.

Once the first node N1a (“glycoprotein”) and the second node N2a (“blood platelet”), have been determined and examined, further nodes and further edge property values of the further connecting edges to the first node N1a are determined and examined using, for example, one of the strategies as described above.

With respect to the example shown in FIG. 1, the next most relevant node is the third node N3a because this has the next highest value of the first edge property value of the connecting edge CE2a directly connecting the first node N1a and the third node N3a. The information element associated with the third node N3a will then be the third in the serial list.

The node N3a represents the term “endothel” which is also in close relation with “glycoprotein” and “blood platelet”.

After all relevant nodes (N2a, N3a, etc) of the first order graph 1aa have been determined and examined, the serial list will contain a list of the information items associated with the relevant nodes (N2a, N3a, etc) in the relevant order. As noted above this relevant order is determined by the weighting of the nodes and/or the weighting of the connecting edges between the first node N1a and the further nodes of the first order graph 1aa.

Once all of the nodes in the first order graph 1aa have been examined, the serial list of the information elements contained in the graph 1 can be produced in step 330. The order of the information elements in the serial list will be determined by the order (relevance order) in which the nodes N2a, N3a, etc. are determined with respect to the first node N1a.

In this example the user will obtain the serial list “Von Willebrand factor: glycoprotein—blood platelet—endothel—etc.” This result comes close to the information that the user would expect to obtain relating to the von Willebrand Factor and is similar to a sentence of human language.

The steps described above can be performed with the next first-order graph 1ab of the second most relevant node N1f of the local graph 1a of the graph 1 In step 310 the node N1f which is connected with the initial node IN in the local graph 1a and which has the second largest number of connecting edges to further nodes N2f, N3f, N4a is determined as the first node of the first order graph 1ab. Then the information elements associated with the second first node N1f are added to the serial list. The first order graph lab comprising those nodes N2f, N3f, N4a connected to the node N1f is shown in FIG. 1. In a manner similar to step 320 these nodes N2f, N3f, N4a in the first order graph 1ab are examined and their order of relevance is determined and the corresponding information elements are added to the serial list in accordance to this order of relevance.

It is possible that ones of the nodes (e.g. N2f, N4a) in the first order graph 1ab are common with ones of the nodes N1b, N1c in the first order graph 1aa. In this case, the information elements are not added to the serialized list twice but are ignored.

The method of the invention can be repeated until all of the nodes (N1a, N1f, N1g, etc.) directly connected to the initial node IN and thus their associated first order graphs 1aa, 1ab, 1ac, etc. have been examined and serialized. The serial list is then complete and the method according to the present invention has finished.

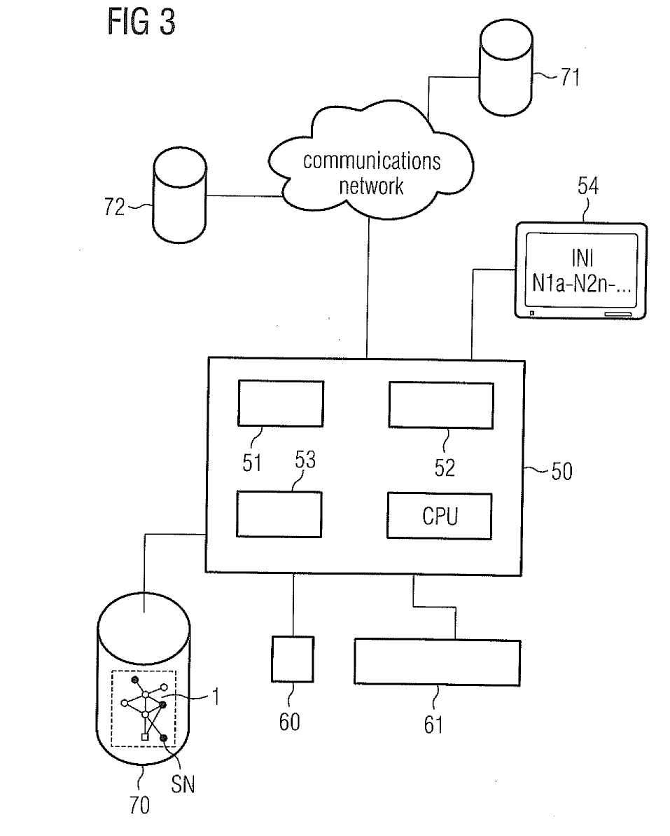

FIG. 3 shows an example of a schematic representation of an apparatus 50 for performing the method according to the invention. The apparatus 50 can be, for example, an electronic data processing apparatus such as a personal computer, a server, a web-server, a terminal, a PDA, etc. with access to at least one electronic file, i.e. information source database and/or to a mobile communications network with access to electronic information sources such as downloadable text documents, web pages, etc.

Further, the apparatus 50 can be a mobile communications device such as a mobile phone, a smart phone, etc. The apparatus 50 can also be, for example, part of a electronic data processing apparatus such as a server, personal computer, PDA, laptop, etc. or a mobile telephone or any kind of electronic apparatuses for communication or with access to a storage device or a communications network storing or providing one or more information sources as described above.

The apparatus 50 of FIG. 3 comprises at least one graph examination and determination engine 51 for selecting and examining an initial node of the plurality of nodes and determining at least one of the at least one node property values of first order connecting nodes connected to the initial node. Further, the graph examination and determination engine 51 can determine a first node connected to the initial node having a highest value of the at least one node property value. Further, the graph examination and determination engine 51 can examine further first order connecting nodes connected to the first node. The apparatus 50 further comprises at least one serializing engine 52 for serializing the first order connecting nodes connected to the first node and determining a relevance order of the first order connecting nodes connected to the first node and producing a serial list in accordance with the relevance order of the first order connecting nodes.

The apparatus 50 can further comprise at least one output device 54 for presenting the serialized list of information elements.

The apparatus 50 of FIG. 3 is further connected to data input devices such as a keyboard 61, a pointing device (e.g. a computer mouse) 60, etc. The apparatus 50 may further be connected to an external database 70 storing, for example the graph 1. The external database 70 may be connected directly to the apparatus 50. Further databases 71, 72, storing, for example, further graphs, may be accessible via a communications network such as the Internet to the apparatus 50. The apparatus 50 may be in hardware and/or software. Since the apparatus 50 is a computer it may further comprise further components 53, for example, a CD-ROM/DVD drive, a floppy drive, a hard drive, a disk controller, a ROM memory, a RAM memory, communication ports, a central processing unit, etc.

Since the invention has been described in terms of single examples, those skilled in the art will recognize that the invention can be practiced with modification within the spirit and scope of the attached claims.

In this respect, it is to be noted that the invention is not limited to the detailed description of the invention and/or of the examples of the invention. It is clear to the person of ordinary skill in the art that the invention can be realized at least partially in hardware and/or software and can be transferred to several physical devices or products. The invention can be transferred to at least one computer program product. Further, the invention may be realized with several devices.

What is claimed is:

1. A method for serializing a plurality of information elements extracted from at least one information source, each one of the plurality of information elements being represented by one of a plurality of nodes in a semantic network, ones of the plurality of nodes being connected to other ones of the plurality of nodes in the semantic network via a plurality of connecting edges, at least one edge property value being associated with each one of the plurality of connecting edges and at least one node property value being associated with each one of the plurality of nodes, the method comprising:
selecting an initial node of the plurality of nodes and determining at least one of the at least one node property values of first order connecting nodes connected to the initial node;
determining a first node having a highest value of the at least one node property value;
examining further first order connecting nodes connected to the first node and determining a relevance order of the further first order connecting nodes connected to the first node; and
serializing the plurality of information elements in accordance with the relevance order of the further first order connecting nodes to produce a serial list.

2. The method according to claim 1, wherein the at least one node property value of the first node comprises the number of connecting edges to which the further first order connecting nodes are connected to the first node and the first node property value comprising the highest number of the connecting edges.

3. The method according to claim 1, wherein the relevance order is determined by examining a product of the at least one node property value and the at least one edge property value of the connecting edge between the first node and the first order connecting node.

4. The method according to claim 1, further comprising:
determining a second node connected to the initial node with the second highest value of the at least one node property value;
examining further first order connecting nodes connected to the second node and determining a relevance order of the first order connecting nodes connected to the second node; and
serializing a further plurality of information elements in accordance with the relevance order of the further first order connecting nodes and adding the further plurality of information elements to the serial list.

5. The method according to claim 1, wherein the information elements are selected from the group consisting of subject nouns, verbs or object nouns.

6. The method according to claim 1, wherein each one of the plurality of serialized information elements represents another one of the plurality of serialized information elements than a further one of the plurality of serialized information elements.

7. The method according to claim 1, wherein the at least one edge property value is selected from the group consisting of a frequency number and activation information.

8. An apparatus for serializing a plurality of information elements extracted from at least one information source, each one of the plurality of information elements being represented by one of a plurality of nodes in a semantic network, ones of the plurality of nodes being connected to other ones of the plurality of nodes in the semantic network via a plurality of connecting edges, at least one edge property value being associated with each one of the plurality of connecting edges and at least one node property value being associated with each one of the plurality of nodes, the apparatus comprising:
a graph examination and determination engine for examining an initial node of the plurality of nodes and determining at least one of the at least one node property value of first order connecting nodes connected to the initial node and determining a first node connected to the initial node by the connecting edge having a highest value of the at least one node property value; and
a serializing engine for examining first order connecting nodes connected to the first node and determining a relevance order of the first order connecting nodes connected to the first node and producing a serial list in accordance with the relevance order of the first order connecting nodes.

9. The apparatus according to claim 8, further comprising an output device for presenting the serialized list.

10. A computer readable tangible medium storing instructions for implementing a process driven by a computer, the instructions controlling the computer to perform the process of serializing a plurality of information elements extracted from at least one information source, each one of the plurality of information elements being represented by one of a plurality of nodes in a semantic network, ones of the plurality of nodes being connected to other ones of the plurality of nodes in the semantic network via a plurality of connecting edges, at least one edge property value being associated with each one of the plurality of connecting edges and at least one node property value being associated with each one of the plurality of nodes, the serializing of a plurality of information elements comprising:
selecting an initial node of the plurality of nodes and determining at least one of the at least one node property values of first order connecting nodes connected to the initial node;
determining a first node connected to the initial node by the connecting edge having a highest value of the at least one node property value;
examining further first order connecting nodes connected to the first node and determining a relevance order of the further first order connecting nodes connected to the first node; and
serializing the plurality of information elements in accordance with the relevance order of the further first order connecting nodes to produce a serial list.

11. A computer program product, being loadable into at least one memory of a computer readable tangible medium or into an electronic data processing apparatus, the computer program product comprising program code means to perform serializing a plurality of information elements extracted from at least one information source, each one of the plurality of information elements being represented by one of a plurality of nodes in semantic network, ones of the plurality of nodes being connected to other ones of the plurality of nodes in the semantic network via a plurality of connecting edges, at least one edge property value being associated with each one of the plurality of connecting edges and at least one node property value being associated with each one of the plurality of nodes, the serializing of a plurality of information elements comprising:
selecting an initial node of the plurality of nodes and determining at least one of the at least one edge node values of first order connecting nodes connected to the initial node;
determining a first node connected to the initial node by the connecting edge having a highest value of the at least one node property value;
examining further first order connecting nodes connected to the first node and determining a relevance order of the further first order connecting nodes connected to the first node; and
serializing the plurality of information elements in accordance with the relevance order of the further first order connecting nodes to produce a serial list.

12. The computer program product wherein the program code means are executed on the computer readable tangible medium or on the electronic data processing apparatus.
